(19) United States
(12) Patent Application Publication
(10) Pub. No.: US 2006/0070528 A1
(43) Pub. Date: Apr. 6, 2006

(54) Method of preparing instant coffee containing aroma extract

(76) Inventors: Se-il Kim, Incheon (KR); Dong-Hoon Lim, Seoul (KR)

Correspondence Address: IPLA P.A., 3580 WILSHIRE BLVD., 17TH FLOOR, LOS ANGELES, CA, 90010, US

(21) Appl. No.: 10/547,872

(22) PCT Filed: Mar. 18, 2004
(86) PCT No.: PCT/KR04/00589

§ 371 Date: Sep. 2, 2005

(30) Foreign Application Priority Data
Mar. 18, 2003 (KR) 10 2003-0010919

(51) Int. Cl. A47J 31/00

(52) U.S. Cl. 99/279

(57) ABSTRACT

With respect to preference and flavor, freshly brewed coffee is superior to instant coffee. However, brewed coffee is inconvenient upon its preparation because coffee requires storage of the coffee beans and the roasting, grinding and extraction steps. Instant coffee is convenient in storage of coffee powder and brewing of coffee, but has disadvantages of being less preferred and poorly flavorful. Disclosed is a method of preparing instant coffee containing an aroma extract. The method includes preparing coffee powder by roasting dried coffee beans in an agitator at 50-100 rpm at 200-250° C., grinding the roasted coffee beans, extracting the ground coffee beans with purified water under reflux at a boiling point, and concentrating, freeze-drying and grinding the coffee extract; automatically spraying a liquid-phase aroma extract of 0.01-5 wt %, based on the total weight of coffee powder contained in the instant coffee, through a spray nozzle below 10° C. into the coffee powder of 5-15 wt %, based on the total weight of coffee powder contained in the instant coffee, with agitation; filtering the mixture with a sieve; and mixing the filtrate with the residual part of the total coffee powder.

### TECHNICAL FIELD

The present invention, in general, relates to a method of preparing instant coffee containing an aroma extract. More particularly, the present invention relates to a method of preparing instant coffee containing an aroma extract and having improved preference and flavor, including extracting coffee beans under continuous reflux below a boiling point; concentrating the coffee extract under pressure; freeze-drying and grinding the coffee concentrate; and permeating a liquid-phase aromatic into the coffee powder.

### BACKGROUND ART

Coffee plants are evergreen shrubs that belong to the Rubiaceae family, and originally grew in tropical climates having a rainfall of 1,500-2,000 millimeters every year. High-quality coffee is produced at altitudes as high as 1,000-3,000 meters above sea level. Three coffee plants are cultivated for commercial purposes, which are Arabica, Robusta and Liberica. Among them, two species, Arabica and Robusta are predominantly used in the world's coffee market.

Coffee is a globally preferred drink. In particular, freshly brewed coffee gives the innate taste and fragrance of coffee beans because of being freshly made by roasting and grinding a blend of dried coffee beans and extracting the coffee powder with hot water.

In contrast, instant coffee is a powdered or particle-shaped coffee, which is typically made by filtering roasted and ground coffee beans, evaporating water from the filtrate and freeze-drying or spray-drying the resulting coffee extract. Thus, instant coffee is consumable simply by being dissolved in hot water.

Instant coffee was imported in around 1890 to Korea, and, after that, its consumption tremendously increased. Now, instant coffee is one of the most preferred foods in Korea.

On the other hand, some efforts have been recently made to improve functionality, preference and/or flavor of freshly brewed coffee and instant coffee. For example, liquid-phase aromatic substances such as hazelnut were added to freshly brewed coffee. As another example, powdered aromatics or herbs were added to instant coffee.

A functional instant coffee can be prepared as described in Korean Pat. Application No. 99-0018589, in which a method of preparing a herb coffee is disclosed, comprising animal-derived materials (e.g., young antlers, overgrown antlers, etc.), the insect order Insecta- or Isoptera-derived materials (e.g., silkworms, honey, shells of wasps, etc.), the insect order Chilopoda- or Homoptera-derived materials (e.g., centipede, shells of cicadas, etc.), and/or mushrooms (e.g., ganoderma mushroom, Colriolus versicolor mushroom, shiitake mushroom, etc.). Also, Korean Pat. Application No. 2000-030404 discloses a method of preparing a herb coffee, comprising preparing coffee powder by roasting a blend of dried coffee beans at 200-250° C., grinding the roasted beans, extracting the ground beans under reflux at a boiling point with purified water, and concentrating, freeze-drying and grinding the coffee extract; preparing a powdered herb extract by mixing chicory, atractylodes, Eleutherococus plants, arrowroots, ginkgo leaves, young antlers, Korean angelica roots, cornus fruits, ganoderma mushroom and pumpkin in predetermined amounts, grinding the herb mixture, extracting the ground herb mixture under reflux with purified water, and concentrating, freeze-drying and grinding the herb extract; and mixing the coffee powder of 90-99 wt % and the powdered herb extract of 1-10 wt %. However, the immediately above method cannot maintain the natural fragrance and taste of herbs since aromatic substances are volatilized during freeze-drying or by heat generated by friction for the grinding step.

As described above, since freshly brewed coffee is made by extracting coffee beans with hot water, liquid-phase aromatics are evenly dispersed in the freshly brewed coffee, and retained therein for a longer period. In contrast, when instant coffee is supplemented with liquid-phase aromatics, coffee powder lumps while the aromatics are not evenly distributed in the instant coffee. For this reason, many functional substances have been used at powdered states.

Therefore, with respect to preference and flavor, freshly brewed coffee is superior to instant coffee. However, freshly brewed coffee is inconvenient upon its preparation because coffee requires storage of the coffee beans and the roasting, grinding and extraction steps. Instant coffee is convenient in storage of coffee powder and brewing of coffee, but has disadvantages of being less preferred and poorly flavorful.

### DISCLOSURE OF THE INVENTION

### Technical Problem

Leading to the present invention, the intensive and thorough research into instant coffee having improved preference and flavor as high as freshly brewed coffee resulted in the finding that, when a liquid-phase aroma extract is added to instant coffee through a spray nozzle by spraying, the instant coffee has greatly improved preference and flavor.

### Technical Solution

It is therefore an object of the present invention to provide a method of preparing instant coffee containing an aroma extract, which is capable of improving preference and flavor of the instant coffee.

To achieve the above object, the present invention provides a method of preparing instant coffee comprising coffee powder, cream and sugar, including preparing coffee powder by roasting dried coffee beans in an agitator at 50-100 rpm at 200-250° C., grinding the roasted coffee beans, extracting the ground coffee beans with purified water under reflux at a boiling point, and concentrating, freeze-drying and grinding the coffee extract; automatically spraying a liquid-phase aroma extract of 0.01-5 wt %, based on the total weight of coffee powder contained in the instant coffee, through a spray nozzle below 10° C. into the coffee powder of 5-15 wt %, based on the total weight of coffee powder contained in the instant coffee, with agitation; filtering the mixture with a sieve; and mixing the filtrate with the residual part of the total coffee powder.

### Advantageous Effects

The present method that is characterized by permeating a liquid-phase aroma extract into coffee powder can provide a variety of instant coffee meeting the preference of consumers and changes in the consumer preference. Therefore, the instant coffee prepared according to the present method has the preference and flavor similar to freshly brewed coffee. In addition, because of containing the coffee powder in combination with the aroma extract, the instant coffee prepared according to the present invention has the natural taste and fragrance of coffee, as well as being beneficial to health.

### Best Mode

In accordance with the present invention, instant coffee is prepared by permeating a liquid-phase aroma extract through a spray nozzle into coffee powder of 5-15 wt %, based on the total weight of coffee powder in the instant coffee, with agitation; filtering the mixture with a sieve; and mixing the filtrate with the residual part of the coffee powder.

Typically, instant coffee is composed of coffee powder of 15-30 wt %, sugar of 40-50 wt % and cream of 30-40 wt %. The coffee powder used in the present invention is prepared according to a conventionally known process of preparing instant coffee. In detail, the coffee powder is prepared by the following procedure. At step 1, coffee beans are pealed off and dried by a dry method using sunlight or hot blast, or a wet method using water.

At step 2 in the procedure of processing coffee powder, the dried coffee beans are roasted. This roasting is necessary to make coffee beans consumable, which is carried out by forcing hot air of 200-250° C. through the dried coffee beans to cause physical and chemical changes in the coffee beans, thus generating the unique taste and fragrance of coffee. This roasting is a first step of conferring to coffee unique taste and flavor, which are the most critical factors determining the preference for coffee.

During the roasting of the coffee beans, the major physical change of the coffee beans is a reduction in weight. That is, when coffee beans are exposed to the hot air, the hot air evaporates water in the coffee beans, resulting in a reduction to 15-20% in weight of the coffee beans. Also, the hot air takes out heavy gas such as carbon compounds and oxidizes thereof from the coffee beans, leading to a further reduction in the weight of the coffee beans. Further, during the roasting step, the pressure in the inside of the coffee beans is elevated, thus increasing the volume of the coffee beans by 60%. Due to the reduction in weight and the increase in volume, coffee beans become less-elastic and are thus easy to pulverize. Commercially available coffee is brown. When coffee beans not roasted are heated, decoloring substances are generated by Strecker degradation, while sugars turn to caramels by a caramel reaction, resulting in that the coffee beans turn brown. This caramelization of coffee beans occurs at high temperature. The higher the temperature is, the darker coffee is. In the roasting step, about 700 substances are newly generated, which include caramels, carbohydrates and volatile aromatics and account for about 30% of the total weight of roasted coffee beans.

At step 3 in the procedure of processing coffee powder, the roasted coffee beans are ground. This grinding step is carried out to facilitate obtainment of a liquid-phase coffee extract from the roasted coffee beans.

At step 4 in the procedure of processing coffee powder, the ground coffee beans are subjected to continuous reflux extraction at a low temperature of below a boiling point to produce a liquid-phase coffee extract.

At step 5 in the procedure of processing coffee powder, the liquid-phase coffee extract is concentrated under pressure into granules.

At step 6 in the procedure of processing coffee powder, the coffee granules are freezedried.

At step 7 in the procedure of processing coffee powder, the freeze-dried coffee particles are ground into particles with a predetermined size, thus yielding coffee powder to be used in preparation of the instant coffee of the present invention.

In accordance with the present invention, a liquid-phase aroma extract is permeated into the coffee powder prepared as described above. Conventionally, when liquid-phase aromatics are added to instant coffee, coffee powder lumps while the aromatics are not evenly distributed in the instant coffee. For this reason, there is no attempt to add liquid-phase aromatics to instant coffee.

Typically, when a liquid-phase aroma extract is directly permeated into the whole of coffee powder, it is unevenly permeated into the coffee powder, or the coffee powder lumps or coagulates. In this regard, the liquid-phase aroma extract is permeated into coffee powder of a small quantity, and preferably, 5-15 wt % based on the total weight of coffee powder contained in the instant coffee of the present invention, with agitation at 50-100 rpm at a low temperature of below 10° C. by automatic spraying through a spray nozzle. Then, the coffee powder is passed through a sieve, and the filtrate is mixed with the residual part of the coffee powder.

As described above, the present method of preparing instant coffee has advantages of minimizing the coagulation of coffee powder or the formation of lumps by automatically spraying the aroma extract through a spray nozzle into the coffee powder and filtering the coffee powder with a sieve; and of evenly distributing the aroma extract in the coffee powder by primarily adding the aroma extract to only a small quantity of the total coffee powder and then mixing the aroma extract-sprayed coffee powder with the residual coffee powder. Also, the advantages of the present method include inhibiting the volatilization of the aroma extract and thus preserving the aroma in instant coffee for a longer time by permeating the aroma extract into the coffee powder at a low temperature of below 10° C.

In accordance with the present invention, the aroma extract is used in an amount of 0.01-5 wt %, and preferably, 0.1-3 wt %, based on the total weight of coffee powder. When the aroma extract is used in an amount of below 0.01 wt %, its addition is not effective. In contrast, the case in that the content of the aroma extract exceeds 5 wt % is undesirable with respect to costs, preference and flavor.

The term “aroma extract or aromatic”, as used herein, refers to an organic substance with strong fragrance, which is generally used to supply fragrance to daily-used articles. About 400-500 aromatic substances are known, which are highly volatile at room temperature.

The aroma extracts are classified into three groups: natural aromatics obtained from rose, lemon, etc.; isolated or purified aromatics from cheap natural aromatics; and synthetic aromatics synthesized by chemical reactions. The isolated or purified aromatics and the synthetic aromatics are called artificial aromatics. Also, the aroma extracts are divided into cosmetic aromatics and food aromatics according to their use. The cosmetic aromatics are used only for supply fragrance to cosmetic products, whereas the food aromatics offer flavor that is an integration of smell and taste.

In the present invention, raw materials for preparation of the aroma extract include mints such as northmint, pepper mint and spear mint; lavender, rosemary, hazelnut, irish, nasturtium, dill, roselle, rocket salad, marjoram, basil, borage, anice, german chamomile, chervil, coriander, corn salad, angelica, caraway, lovage, lady's mantle, lemon grass, lemon balm, roman chamomile, rhubard, marsh mallow, mallow, bergamot, scented geranium, santolina, salad burnet, sweet cicely, stevia, varrow, oregano, chives, tarragon, cresson, fennel, hyssop, lemon verbena, myrtle, bay, sage, curry plant, thyme and mixtures thereof.

Taking a look into some raw materials, mints are plants that have menthols and produce mint oils. Mints are used for medical purposes in gastroenteric troubles, headache, cholera infection, diarrhea, hysterics, neuralgia, rheumatoid arthritis, dentalgia, puerperal fever and puerperal pain. Also, mints are known to have the following effectiveness: anti-inflammatory effect, sedative effect, analgesic effect, diaphoretic effect, antiseptic effect and colds-treating effect.

In the present invention, a mint aroma extract is permeated into coffee powder by direct spraying to preserve the innate fragrance and flavor of mints and deeply permeate the mint aroma into coffee particles, resulting in prolonged preservation of the mint aroma The lavender has antibacterial, disinfecting, antiseptic, insecticidal, hypnotic, sedative and analgesic effects. Thus, the lavender has pharmaceutical effects in fatigue, headache, insomnia, melancholia, uneasiness and impatience, bronchitis, neuralgia, rheumatoid arthritis, myalgia, burns, body areas bitten by insects, and the like, and, in particular, is effective in psycho-neurotic stabilization.

The rosemary has antibacterial, disinfecting, insecticidal and antioxidant effects, and thus helps preservation of foods. EI addition, the rosemary has analeptic, sedative, the stomach and digestive system-stimulating, astringent, antiflatulent and antibacterial effects and stimulates the central nervous system and blood circulation, and thus used in treating myalgia, neuralgia, rheumatoid arthritis, fatigue including metal fatigue, arthritis and melancholia. In particular, rosemary tea or alcoholic beverages have therapeutic efficacy on headache, colds and neuralgia, and refreshing and aging-preventing effects. Rosemary fragrance promotes brain activity and enhances memory and concentration power.

In addition to the mints, lavender and rosemary, other herbs described as above are also known to have a variety of functions.

When the coffee powder is packed immediately after being supplemented with the aroma extract, the offensive taste and smell of the aroma extract remain in the packed coffee powder, resulting in a reduction in the quality of instant coffee products. Thus, a maturation step is needed. According to the present invention, the coffee powder mixed with the aroma extract is maintained at a tight-sealing state for a predetermined period (about one month) to allow chemical reactions to occur, remaining behind sweet taste and smell.

The coffee maturation actively progresses at room temperature (10-30° C.), rather than at a low temperature (below 10° C.). Therefore, this maturation determines the taste and fragrance of the instant coffee of the present invention.

In accordance with the present invention, after being maturated, the coffee powder is preferably packed at a low temperature (below 10° C.) to minimize the volatilization of the aromatics. Therefore, the resulting coffee containing aroma extracts has the taste and fragrance better meeting the preference of consumers.

On the other hand, the aroma extracts used in the present invention are spotlighted as the alternative medicine called “aromatherapy”, and currently used in the aromatherapy. The aroma extracts improves the preference of coffee by stimulating the olfactory and gustatory nerve.

### Mode for Invention

The present invention will be explained in more detail with reference to the following examples. However, the following examples are provided only to illustrate the present invention, and the present invention is not limited to the examples.

### EXAMPLE 1

First, dried coffee beans were roasted at 230° C., and ground into granules with a predetermined size. The coffee granules were subjected to continuous reflux extraction with purified water below a boiling point. The coffee extract is concentrated under pressure, freeze-dried, and grounded into particles with a predetermined size, thus yielding 30 kg of coffee powder. 3 kg of the coffee powder was mixed with 900 g of a pepper mint aroma extract (purified oil) with agitation at about 70 rpm at about 5° C., wherein the aroma extract was permeated into the coffee powder through a spray nozzle. Thereafter, the coffee powder with the aroma extract was passed through a sieve, mixed with the residual part of the total coffee powder for 5 min, and maturated at a tightly sealed state for about 45 days.

### EXAMPLE 2

Coffee powder was prepared according to the same method as in Example 1 except for the use of a lavender aroma extract instead of the pepper mint aroma extract.

### EXAMPLE 3

Coffee powder was prepared according to the same method as in Example 1 except for the use of a rosemary aroma extract instead of the pepper mint aroma extract.

### EXAMPLE 4

Coffee powder was prepared according to the same method as in Example 1 except for the use of pepper mint, lavender and rosemary aroma extracts in an amount of 300 g, respectively.

### EXPERIMENTAL EXAMPLE 1

Using each coffee powder prepared in Examples 1 to 4, instant coffee was made in a composition of 25 wt % of coffee powder, 30 wt % of cream and 45 wt % of sugar. Each of the instant coffees was subjected to sensory tests for taste and fragrance, and compared to a control not supplemented with the aroma extract. Total 300 panelists participated in the sensory tests, and evaluated the instant coffee based on a full grade of 5. The resulting mean values are given in Table 1, below.

TABLE 1

| | Taste | Color | Fragrance | Overall evaluation |
|---|---|---|---|---|
| Example 1 | 4.8 | 4.1 | 4.8 | 4.8 |
| Example 2 | 4.9 | 4.0 | 4.7 | 4.7 |
| Example 3 | 4.9 | 4.2 | 4.7 | 4.7 |
| Example 4 | 4.7 | 4.1 | 4.6 | 4.6 |
| Control | 3.2 | 4.1 | 2.9 | 3.1 |

Note:
1: very bad;
2: bad;
3: ordinary;
4: good; and
5: excellent

As shown in Table 1, all of the instant coffees according to the present invention were found to have satisfactory results in taste, fragrance and overall evaluation.

1. A method of preparing instant coffee comprising coffee powder, cream and sugar, the method comprising:
preparing coffee powder by roasting dried coffee beans in an agitator at 50-100 rpm at 200-250° C., grinding the roasted coffee beans, extracting the ground coffee beans with purified water under reflux at a boiling point, and concentrating, freeze-drying and grinding the coffee extract;
automatically spraying a liquid-phase aroma extract of 0.01-5 wt %, based on the total weight of coffee powder contained in the instant coffee, through a spray nozzle below 10° C. into the coffee powder of 5-15 wt %, based on the total weight of coffee powder contained in the instant coffee, with agitation;
filtering the mixture with a sieve; and
mixing the filtrate with the residual part of the total coffee powder.

2. The method as set forth in claim 1, wherein the aroma extract is obtained from mints such as northmint, pepper mint and spear mint, lavender, rosemary, hazelnut, irish, nasturtium, dill, roselle, rocket salad, marjoram, basil, borage, anice, german chamomile, chervil, coriander, corn salad, angelica, caraway, lovage, lady's mantle, lemon grass, lemon balm, roman chamomile, rhubard, marsh mallow, mallow, bergamot, scented geranium, santolina, salad burnet, sweet cicely, stevia, varrow, oregano, chives, tarragon, cresson, fennel, hyssop, lemon verbena, myrtle, bay, sage, curry plant, thyme and mixtures thereof.

3. The method as set forth in claim 1, further comprising maturating the coffee powder mixed with the aroma extract at a tight-sealing state for over one month at room temperature (10-30° C.).
